(19) United States
(12) Patent Application Publication
(10) Pub. No.: US 2006/0240234 A1
(43) Pub. Date: Oct. 26, 2006

(54) System and method for reinforcing a seam

(76) Inventors: Patrick F. O'Neill, Santa Cruz, CA (US); Randy Glenn Rainey, Chula Vista, CA (US); Gregory M. Clarke, Aptos, CA (US); Mehlin Dean Matthews, Saratoga, CA (US); Mark J. Meltzer, Palo Alto, CA (US)

Correspondence Address: MEHLIN DEAN MATTHEWS, BOX 24, SARATOGA, CA, 95071, US

(21) Appl. No.: 11/112,191

(22) Filed: Apr. 22, 2005

(51) Int. Cl. B32B 37/00; B32B 37/06; B65C 9/25

(52) U.S. Cl. 428/292.1; 156/578; 156/582; 156/499; 156/497; 156/555; 156/322; 156/304.3

(57) ABSTRACT

A seam reinforcing bead for stretchable materials formed by cutting, extrusion, or casting is applied to a seam in conjunction with heat and/or ultrasonic energy. In a system for application the reinforcing bead is fed by a first pair of rollers past a heat source, thereby producing a non-equilibrium temperature distribution within the reinforcing bead. The reinforcing bead is then applied to a seam in a sheet of material and compressed by a second pair of rollers. The reinforcing bead may contain an excess of solvent/plasticizer to reduce viscosity during heating and to aid in the reduction of residual stresses.

### BACKGROUND OF THE INVENTION

1. Field of the Invention

The present invention relates to devices, systems, and methods useful for applying a reinforcing overlay to a seam joining flexible sheet materials.

2. Description of Related Art

The use of butt seams for joining sheets of flexible materials is well known in the art. For example, U.S. Pat. No. 6,375,770 discloses an apparatus and method for forming an adhesively bonded seam between resiliently compressible fabric sheets, such as those used in wetsuits. The seam may be formed using an activated cement.

In joining some flexible materials additional strength is provided by adding reinforcement to the butt seam. For example, U.S. Pat. No. 6,533,891 discloses butt splicing and reinforcing of elastomeric sheets. The reinforcement is provided as an overlay of uncured material. The seam thus formed is subsequently cured in the manufacture of a pneumatic tire.

With respect to the manufacture of wetsuits there are a variety of adhesive tapes that have been used to reinforce seams. These tapes are typically composite structures, having a base material coated with an adhesive. A disadvantage of composite tapes is that when they are applied to a stretchable material, a discontinuity in properties at the tape interface may provide a site for failure nucleation after repeated stretching.

Alternatively, a bead of liquid material may be applied to a wetsuit seam and allowed to cure through reaction or solvent evaporation. The use of solid or liquid uncured materials has the disadvantage of requiring additional time and/or processing for the seam reinforcement to be complete.

Thus, a need exists for an improved system and method for reinforcing seams in flexible sheet materials. A need also exists for a system and method that provides seam reinforcement without requiring a cure, and reduces discontinuities at the reinforcement interface.

### BRIEF SUMMARY OF THE INVENTION

The present invention provides a seam reinforcement that may be applied to a seam without requiring a cure. Further, the seam reinforcement may be applied without an adhesive layer to form a bond to a seam.

In one embodiment of the invention a stretchable material is introduced into a mold as a liquid and allowed to set to produce a length of reinforcing bead that may subsequently be applied to a seam.

In another embodiment a stretchable material is extruded through a die to produce a length of reinforcing bead that may subsequently be applied to a seam.

In a further embodiment a length of homogeneous reinforcing bead is heated to produce a non-equilibrium temperature distribution within it and bonded to a seam using pressure applied by a roller.

In yet another embodiment, a surface of a length of reinforcing bead is heated to produce a non-equilibrium temperature distribution and bonded to a seam using pressure applied by a contoured roller.

### BRIEF DESCRIPTION OF THE DRAWINGS

FIG. 1A shows a perspective view of a reinforcing bead casting plate in accordance with an embodiment of the present invention.

FIG. 1B shows an end view of the reinforcing bead casting plate of FIG. 1A in accordance with an embodiment of the present invention.

FIG. 1C shows a perspective view of the reinforcing bead casting plate of FIG. 1A with added end plug elements in accordance with an embodiment of the present invention.

FIG. 1D shows a perspective view of the reinforcing bead casting plate of FIG. 1C with a cast reinforcing bead in accordance with an embodiment of the present invention.

FIG. 1E shows a sectional view of reinforcing beads applied to a seam in accordance with an embodiment of the present invention.

FIG. 2A shows a perspective view of a system for applying a reinforcing bead to a seam in accordance with an embodiment of the present invention.

FIG. 2B shows a side view of a system for applying a reinforcing bead to a seam in accordance with an embodiment of the present invention.

FIG. 2C shows a perspective view of a guide plate for a reinforcing bead application system in accordance with an embodiment of the present invention.

FIG. 3A shows a front view of a bead application roller with a contoured surface in accordance with an embodiment of the present invention.

FIG. 3B shows a front view of a bead application roller with a flat surface in accordance with an embodiment of the present invention.

FIG. 3C shows a perspective exploded view of a bead application roller a with an integrated vacuum chuck in accordance with an embodiment of the present invention.

FIG. 4A shows a perspective view of a radiant heat source module in accordance with an embodiment of the present invention.

FIG. 4B shows a perspective wireframe view of a radiant heat source module in accordance with an embodiment of the present invention.

FIG. 5 shows a general flow chart of a method for reinforcing a seam in accordance with an embodiment of the present invention.

FIG. 6 shows a front view of a wet suit with seams reinforced in accordance with an embodiment of the present invention.

### DETAILED DESCRIPTION OF THE INVENTION

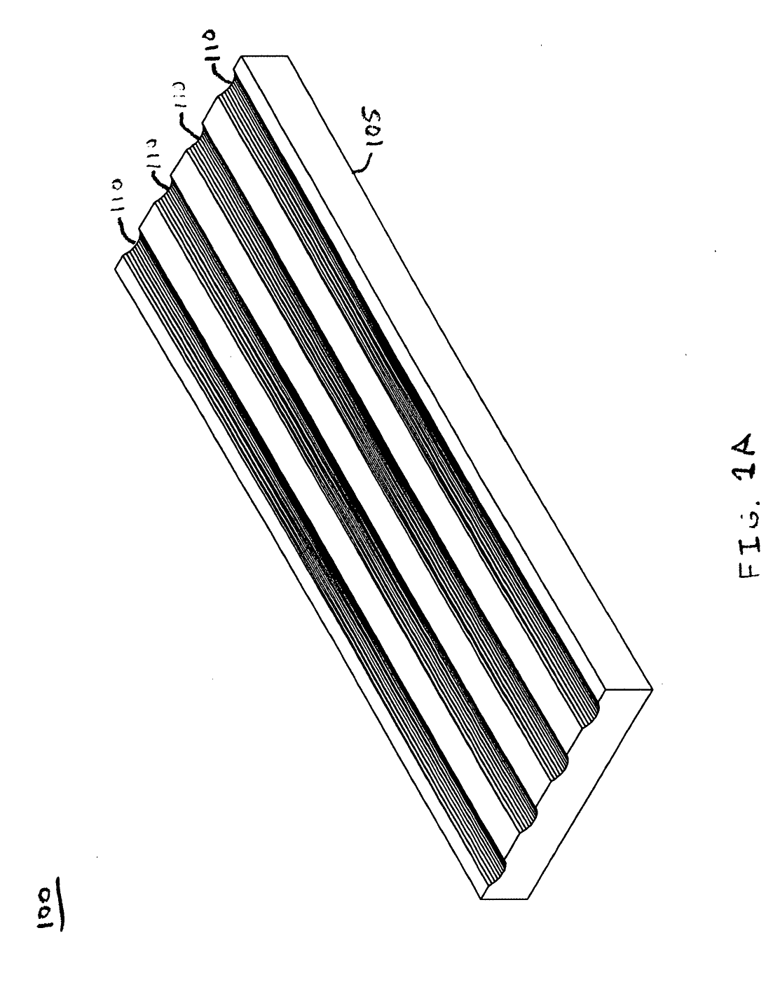

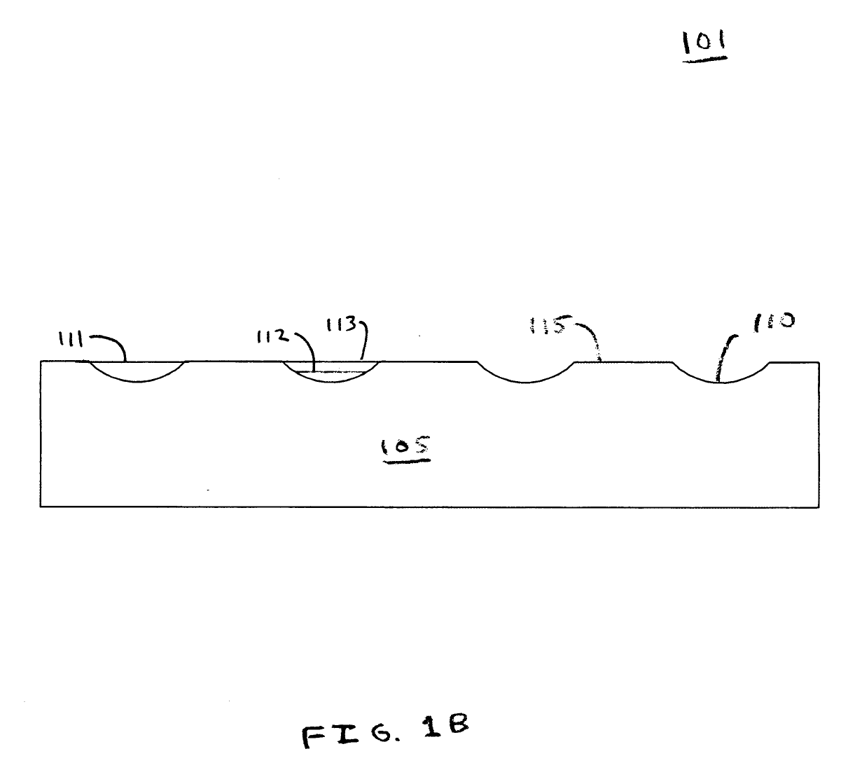

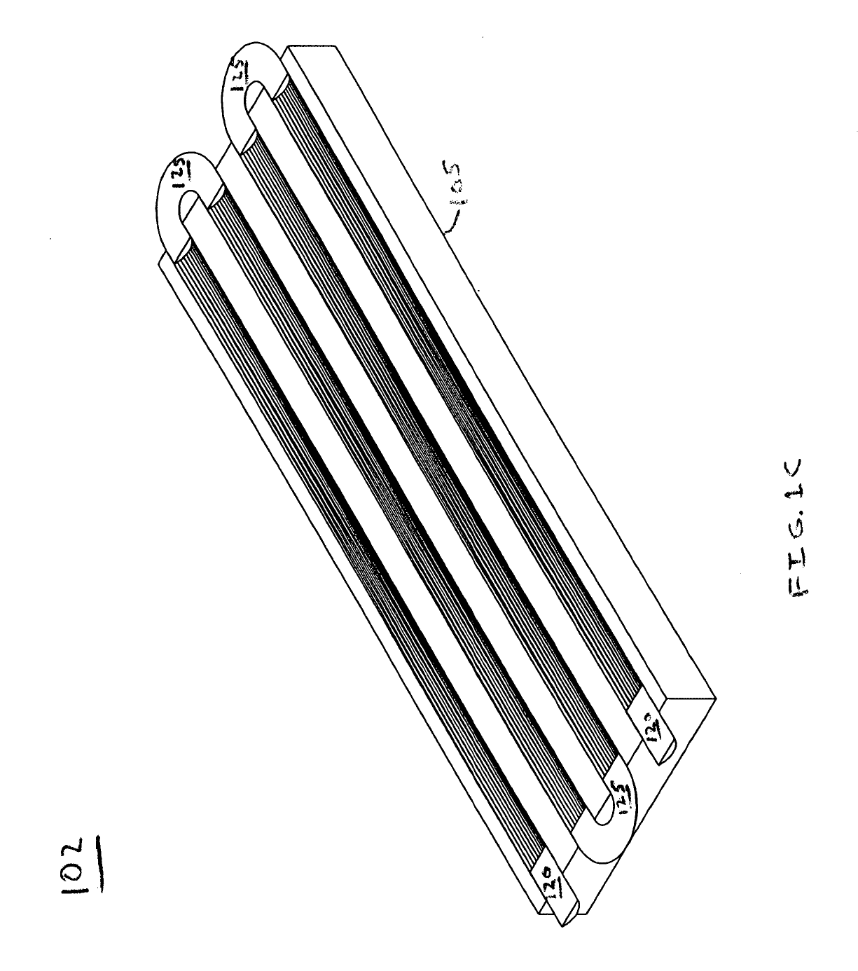

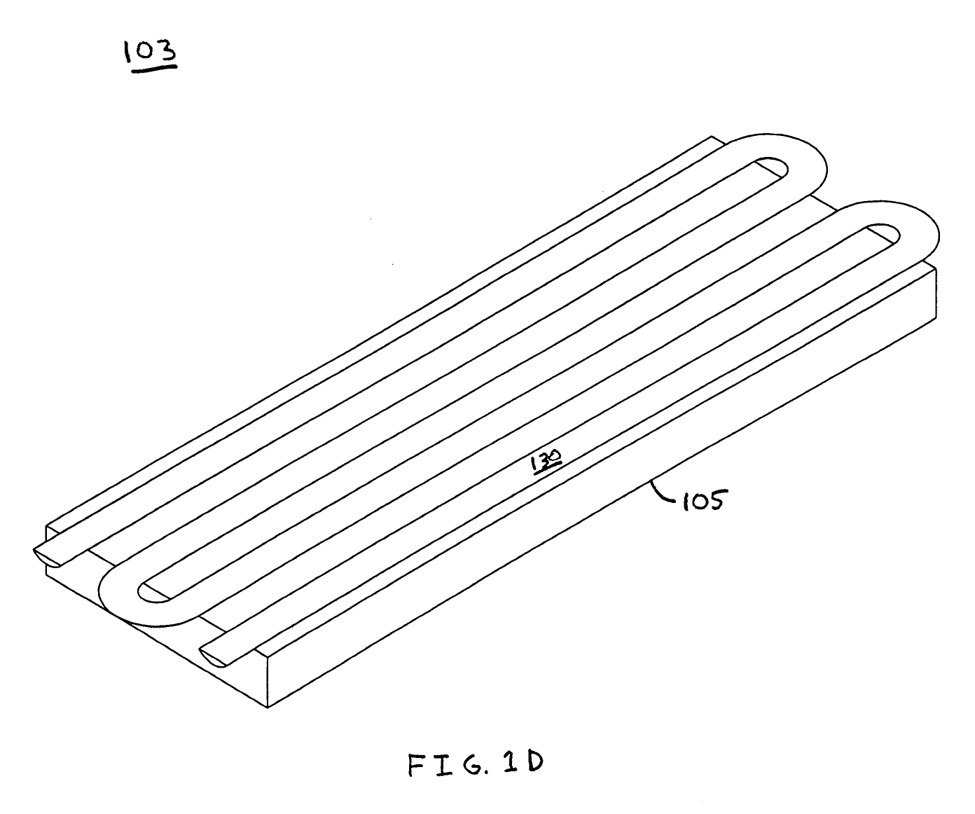

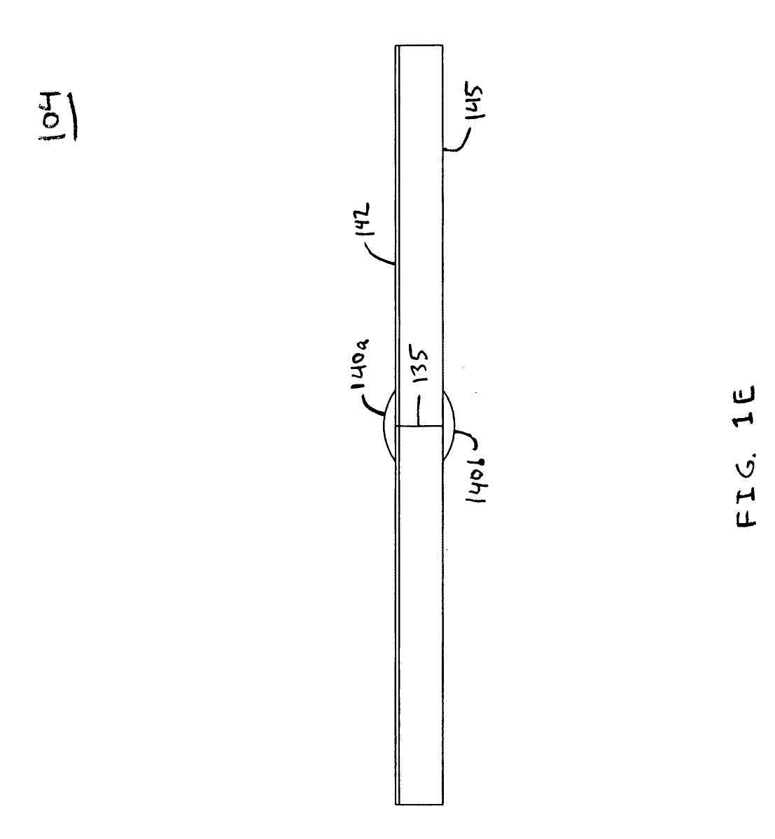

FIG. 1A shows a perspective view 100 of a reinforcing bead casting plate 105. The casting plate 105 has at least on mold groove 110 formed in the top surface to accept a liquid casting material. Each mold groove 110 shown in FIG. 1A is open ended, allowing for the casting of a single reinforcing bead from the casting plate 105. A mold groove 110 may be stopped at its ends to allow for casting of a single reinforcing bead with a length approximately equivalent to that of the groove. This single reinforcing bead may be cut to provide casting couplings or plugs as described below with respect to FIG. 1C.

The material selected for the casting plate 105 is preferably a material that has an inherently low adhesion to a cast material (e.g., a fluoropolymer), or alternatively, a material that may be coated to provide a lower adhesion to a cast material (e.g., aluminum).

Although the groove 110 of FIG. 1A is shown as being essentially linear, a groove having a degree of curvature along its length may also be used. Also, a set grooves having different shapes may be formed on the casting plate 105.

FIG. 1B shows an end view 101 of the reinforcing bead casting plate 105 of FIG. 1A in accordance with an embodiment of the present invention. The groove 110 of FIG. 1B has a cross-section that is a circular arc. Alternatively, elliptical cross-sections or other shapes may be used. An advantage of casting over extrusion is that a feathered, or finely tapered edge is generally easier to obtain. A reinforcing bead with a tapered edge is typically less susceptible to peeling forces.

In a preferred embodiment, the groove 110 has its greatest depth at the centerline, so that the reinforcing bead produced has its greatest thickness at its centerline. A reinforcing bead may be cast by partially filling or completely filling the groove 110 to produce reinforcing bead 111. Thus, the surface of the cast and set reinforcing bead may be at or below the level of the top surface 115 of the casting plate 105.

During the casting operation it is preferable that the casting plate 105 be maintained in a level orientation so that depth of fill for is uniform for each groove 110. In one embodiment, the orientation of the casting plate 105 is adjusted in response to the observed depth of a quantity of casting material placed in at least one groove 110.

A reinforcing bead may be cast in “lifts” with each lift being cast with a liquid casting material of differing properties. For example, the two casting lifts 112 and 113 may have different colors or different mechanical properties.

In casting two lifts with different mechanical properties, the first lift 112 may be cast with a material yielding superior abrasion resistance, while the second lift 113 may be cast with a material having superior bonding characteristics.

In general it is desirable that the surface of the groove 110 be smooth to facilitate removal of the cast and set reinforcing bead. Alternatively, the surface of the groove 110 may be textured so that a matte surface finish is obtained on the cast and set reinforcing bead, instead of a shiny surface finish.

FIG. 1C shows a perspective view 102 of the reinforcing bead casting plate 105 of FIG. 1A with added end plug elements 120 and 125. The terminal plug 120 and coupling plug 125 may be used as end stops for the grooves 110.

The terminal plug 120 and coupling plug 125 may be cut from a previously cast length of reinforcing bead, allowing them to become integrated with a casting to form a length of reinforcing bead that is longer in length than the groove 110.

FIG. 1D shows a perspective view 103 of the reinforcing bead casting plate of FIG. 1C with a cast reinforcing bead 130. Examples of polymer materials that may be cast are polyurethanes and silicones. The setting mechanism for a cast material may include solvent evaporation and/or chemical reaction (e.g., polymerization). A material may also be heated to reduce viscosity, cast, and then set by cooling. Tape casting similar to that used to produce green ceramic substrates may also be used as an alternative to mold casting for low profile reinforcing beads.

FIG. 1E shows a sectional view 104 of reinforcing beads 140a and 140b applied to a seam 135 in a neoprene foam seampiece 145. The upper surface of the seampiece 145 has a woven fabric cladding 142 (e.g., nylon), such as that used in the manufacture of wetsuits. Butt seams in clad neoprene (polychloroprene) foam are typically achieved by a neoprene-to-neoprene bond, with the fabric cladding edges being left exposed.

The discontinuity in the cladding 142 at the seam 135 produces a stress concentration at the surface of the butt seam 135. Reinforcing bead 140a reduces the stress concentration by bridging the seam.

In an embodiment, reinforcing bead 140a is fabricated from flexible polymer having an essentially homogeneous composition, distinguishing it from adhesive tapes and other heterogeneous seam reinforcements. For purposes of this disclosure the term “essentially homogeneous composition” refers to a material in which the basic constituents are uniformly distributed throughout the material, incidental variation of near surface concentrations of volatile components and the granular nature of some filler materials notwithstanding.

The bonding of the reinforcing bead 140a to seam 135 may be accomplished by heating the surface of the reinforcing bead 140a that is to be applied to the seam, so that a non-equilibrium temperature distribution is achieved within the reinforcing bead 140a. Due to the homogeneous nature of the reinforcing bead 140a, a non-equilibrium temperature distribution is desirable so that sufficient overall handling strength in the reinforcing bead 140a is maintained while reducing the viscosity of the bead material at the bonding surface.

A reinforcing bead fabricated from polymer materials (e.g., polyurethane and neoprene) may also include plasticizers (e.g., dioctyl phthalate) and/or solvents (e.g., toluene, methyl ethyl ketone, or N,N dimethylacetamide). Solvents and plasticizers may be used to adjust the viscosity vs. temperature behavior of the reinforcing bead material so that a lower viscosity is obtained at a given temperature. Solvents and plasticizers may also be used to provide a more gradual onset of viscosity reduction during heating.

Since wetsuits are typically worn and used at moderate to low temperatures, a reinforcing bead for wetsuit seams may use a greater concentration of solvent and/or plasticizer than items that are used at elevated temperatures.

For reinforcing bead materials that rely upon solvents or plasticizers with an appreciable vapor pressure, radiant heating is preferred to forced convection heating, since forced convection will deplete the surface of the plasticizer or solvent. Radiant heating is also preferred for systems in which a volatile liquid is applied to the reinforcing bead bonding surface prior to heating.

When reinforcing seams in articles such as wetsuits, the degree of viscosity reduction at the surface of the reinforcing bead 140a is particularly important. Penetration of the woven cladding 142 by the material of reinforcing bead 140a material provides a mechanical interlock that contributes to the bond strength. Mechanical interlock is particularly important when the reinforced substrate and the reinforcing bead materials are not capable of fusion during bonding. For example, a neoprene reinforcing bead on a neoprene substrate would typically exhibit a degree of fusion, whereas a polyurethane reinforcing bead on nylon typically would not.

In a preferred embodiment for reinforcing seams in wetsuits, reinforcing beads 140a and/or 140b are fabricated from a stretchable polymer (e.g., elastomer) and contain a higher than equilibrium concentration of solvent and/or plasticizer at the time of application to seampiece 145. The excess solvent and/or plasticizer may be introduced into the bead material prior to extrusion or casting and maintained by storage in an environment having a higher vapor pressure of the solvent and/or plasticizer than is present in the atmosphere.

For some polymer/plasticizer/solvent systems it may be desirable to extrude the reinforcing bead then subsequently increase the concentration of solvent and/or plasticizer through exposure to vapor or liquid.

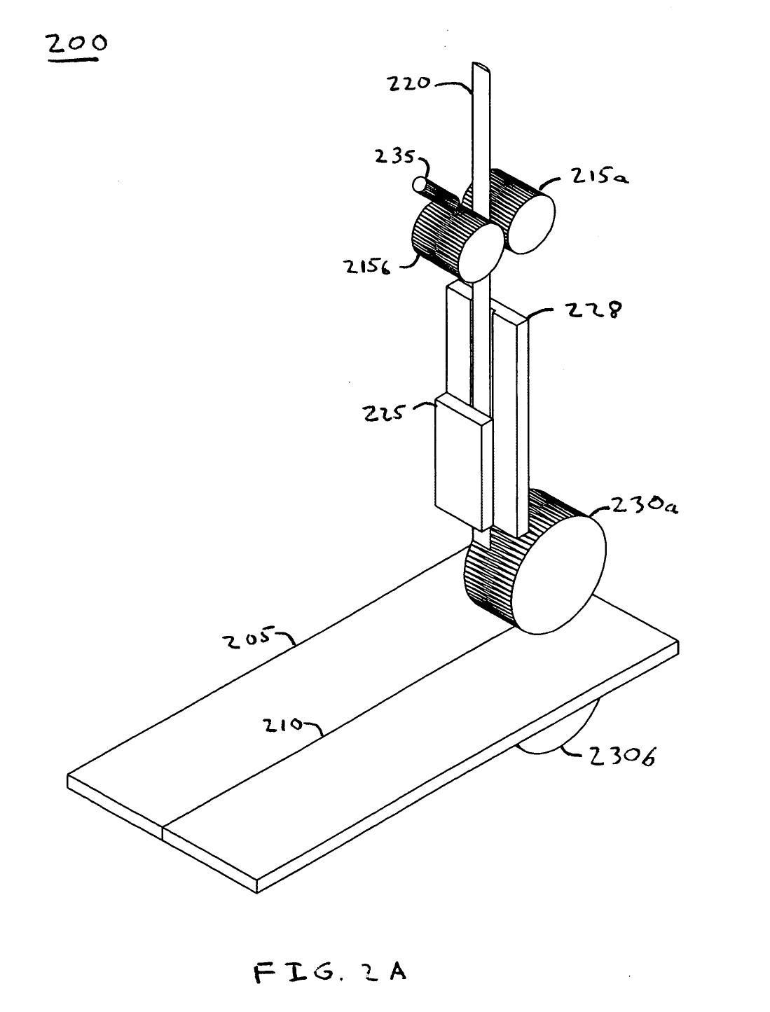

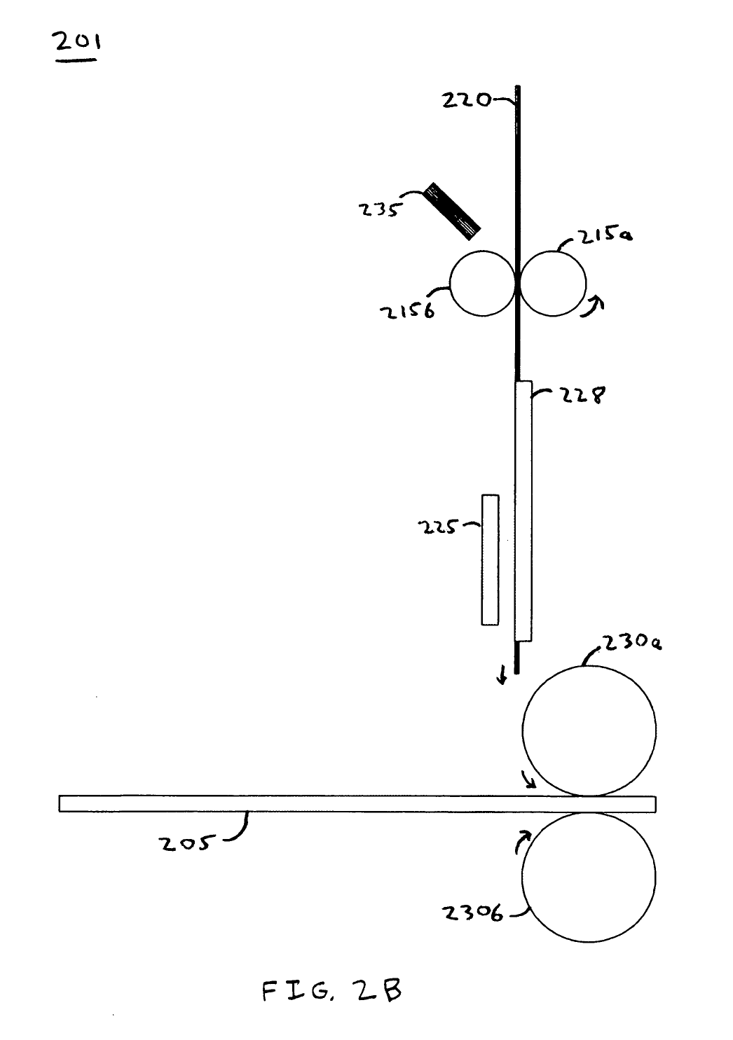

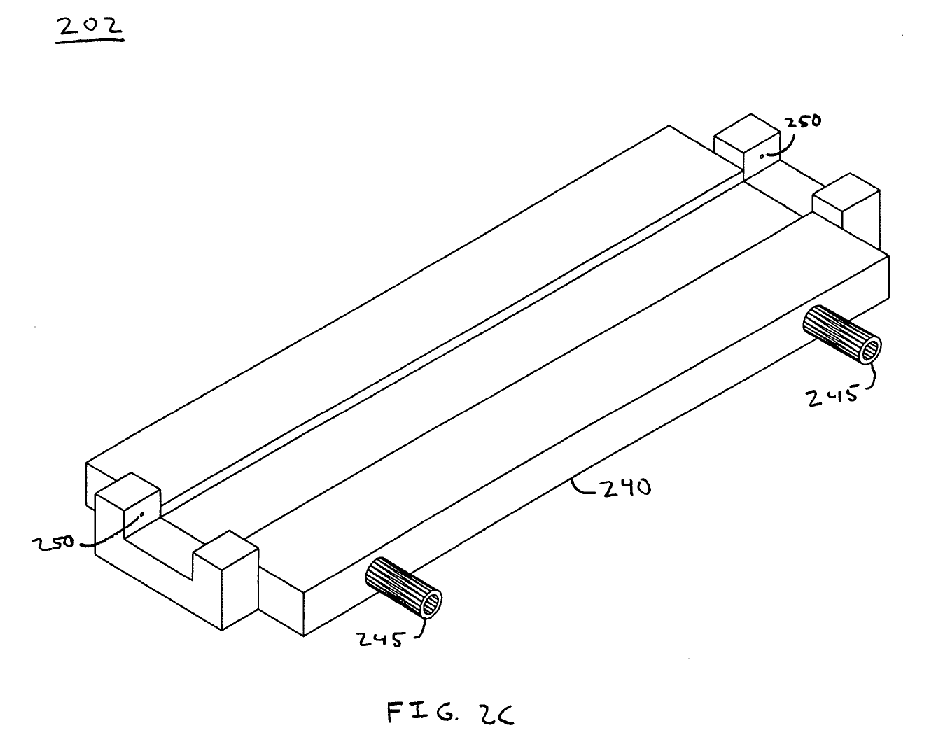

FIGS. 2A and 2B show a perspective view 200 and a side view 201, respectively, of a system for applying a reinforcing bead 220 to a seam 210 in a seam workpiece 205. The reinforcing bead 220 is fed by rollers 215a and 215b, whose rotation may be coupled to that of rollers 230a and 230b so that the tension and linear feed rate of the reinforcing bead 220 may be controlled. In general, a reinforcing bead 220 having a uniform cross-section along its length is preferred so that heating and flow behavior is uniform.

The spacing between roller 215a and 215b and that between 230a and 230b may be adjusted to a fixed value, or the spacing may be dynamically adjustable (e.g., spring loaded). Dynamically adjustable rollers may also be operated at a constant value for closing force that does not vary appreciably with separation.

Roller 230a and 230b may have different radii. For example, roller 230a may have a relatively small radius to allow for the tubular forms (e.g., a wetsuit sleeve) to be inserted over the roller. For the application of a reinforcing bead 220 to a wetsuit sleeve, roller 230a is preferably mounted on an arm to accommodate the sleeve length.

Roller 230b may have a relatively large radius to accommodate an internal ultrasonic generator. The ultrasonic generator may be powered by direct current fed to roller 230b by contact rollers similar to the rolling electrodes commonly used in seam welding equipment for sealing electronic packages.

Ultrasonic energy may be used in addition to or in place of the heat source 225. An ultrasonic generator allows the reinforcing bead to be pre-positioned on the seam 210, whereas positioning of the reinforcing bead heated by heat source 225 must be coordinated with the heat application.

A coupling fluid layer may be applied to the reinforcing bead bonding surface by fluid applicator 235 via roller 215b. Alternatively, a coupling fluid layer may be applied to the seampiece 205 over the seam 210. The coupling fluid layer contains solvent and/or plasticizer that contributes to the reduction in viscosity of the reinforcing bead surface. The combination of heat and deformation under pressure during bonding mixes the coupling fluid layer with the reinforcing bead material. The coupling fluid layer may also be used to enhance coupling of ultrasonic energy to the seampiece 205.

After bonding, the portion of the reinforcing bead 140a that has mixed with the coupling fluid layer will generally be softer and have a lower deformation strength than the unmixed portion of the reinforcing bead. The lower strength of the mixed region helps to minimize residual stress from the bonding operation.

After bonding, The concentration of solvent and/or plasticizer in the reinforcing bead 140a will tend to equilibrate through diffusion and increase the strength of the interfacial region. There will be a concomitant drop in strength and hardness of the unmixed region. The initial composition of the reinforcing bead and the amount of coupling fluid used may be balanced to provide the desired equilibrium composition within the reinforcing bead. When a highly volatile and mobile solvent is used in the coupling fluid, it may ultimately be removed in part from the reinforcing bead through evaporation, resulting in a gradual increase in strength.

The operation of rollers 215a,b and the heat source 225 may be programmed to position the reinforcing bead 220 so that it is not exposed to the heat source 225 at the time the heat source 225 is turned on. This allows the heat source 225 to reach equilibrium without heating the reinforcing bead 220. Alternatively, the heat source 225 may be provided with a shutter to shield the reinforcing bead 220 when it is not being fed to the seam piece 205.

The heat source 225 may be a hot air jet or a radiant (e.g., infrared radiation) heat source. Hot air jets are commonly used on commercial sealing equipment such as the QUEEN LIGHT QHP-905, manufactured by Queen Light Electronic Industries Ltd. However, a radiant heat source is preferred for reinforcing beads that contain volatile compounds.

The forced convection of a hot air jet will tend to deplete the reinforcing bead surface of volatile components when compared to a radiant heat source. For example, a polyurethane-based reinforcing bead may contain a solvent such as toluene. When heating the surface of such a reinforcing bead to prepare the surface for application, the solvent contributes to the tackiness and flowability that enables bonding.

FIG. 2C shows a perspective view 202 of a guide plate 240 for guiding reinforcing bead. Guide plate 240 may serve as guide plate 228 in FIGS. 2A and 2B. Guide plate 228 may include one or more photoelectric cells 250, that may be used to detect the position of the end of the reinforcing bead 220 either before or after the heat source 225. Guide plate 240 has a pair of cooling ports 245 for the circulation of coolant (e.g., water).

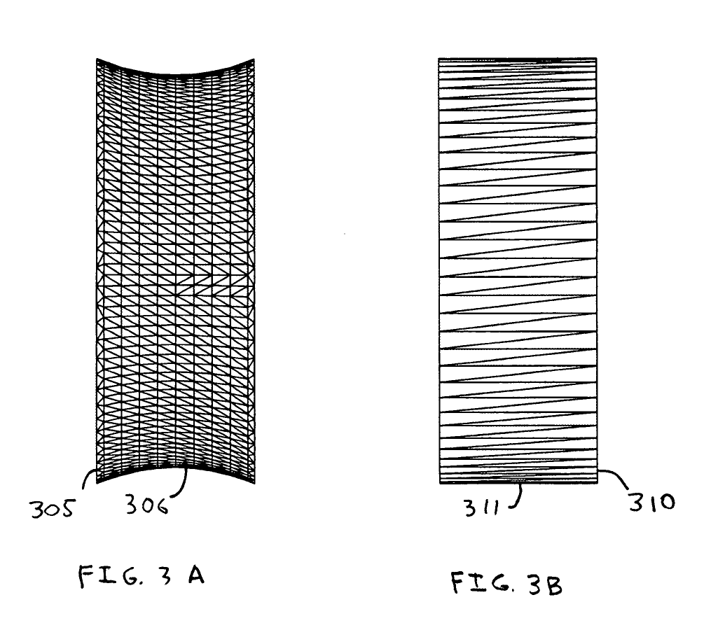

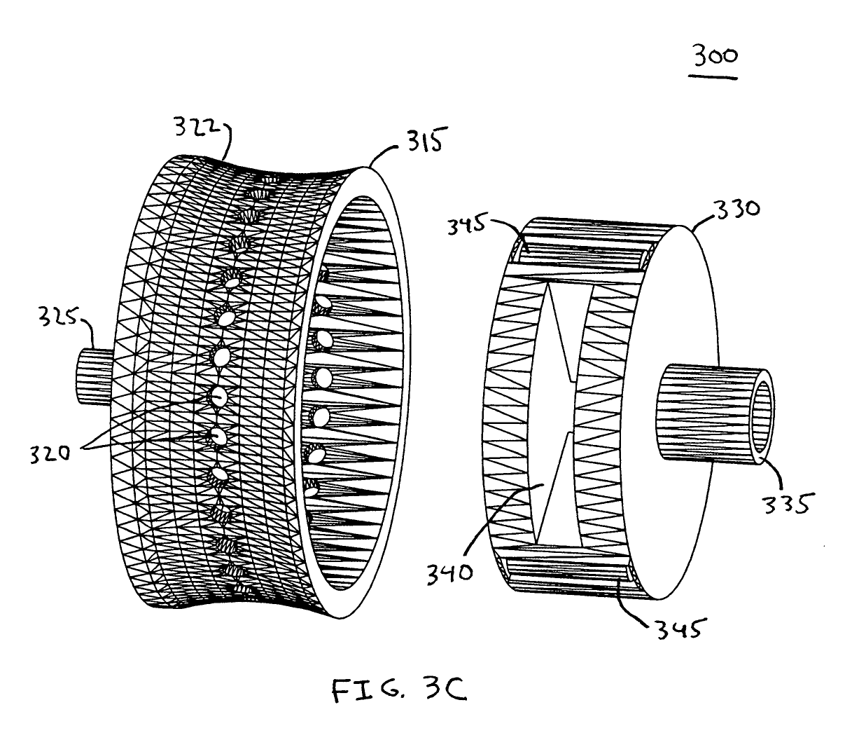

FIG. 3A shows a front view of a bead application roller 305 with a contoured surface 306. The contoured surface 306 is used to modify the stress and strain behavior in the reinforcing bead as it passes between a roller pair. The contour serves to reduce the lateral strain in the reinforcing bead. Roller 305 may also serve as a backup roller that accommodates a first reinforcing bead applied to a seam, while a second bead is being applied on the opposite side of a seampiece.

FIG. 3B shows a front view of a bead application roller 310 with a flat surface 311. The flat surface 311 may be a soft material that yields under pressure to accommodate the shape of the reinforcing bead.

FIG. 3C shows a perspective exploded view of a bead application roller assembly 300. The roller 315 has a series of holes 320 on a contoured surface 322. The roller 315 is driven by shaft 325. Roller core 330 has a vacuum port/support shaft 335 that is coupled to vacuum plenum 340. Roller bearings 345 may be used to reduce rotational friction between roller 315 and roller core 330, and improve the vacuum applied to holes 320. The roller assembly 300 may serve as a rotating vacuum chuck in place of roller 230a in FIG. 2A and FIG. 2B, to capture the reinforcing bead 220 and bring it into contact with the seampiece 205. The combination of photoelectric cells, coupled roller pairs and roller assembly 300 may be used to coordinate the initial heating and placement of the reinforcing bead 220.

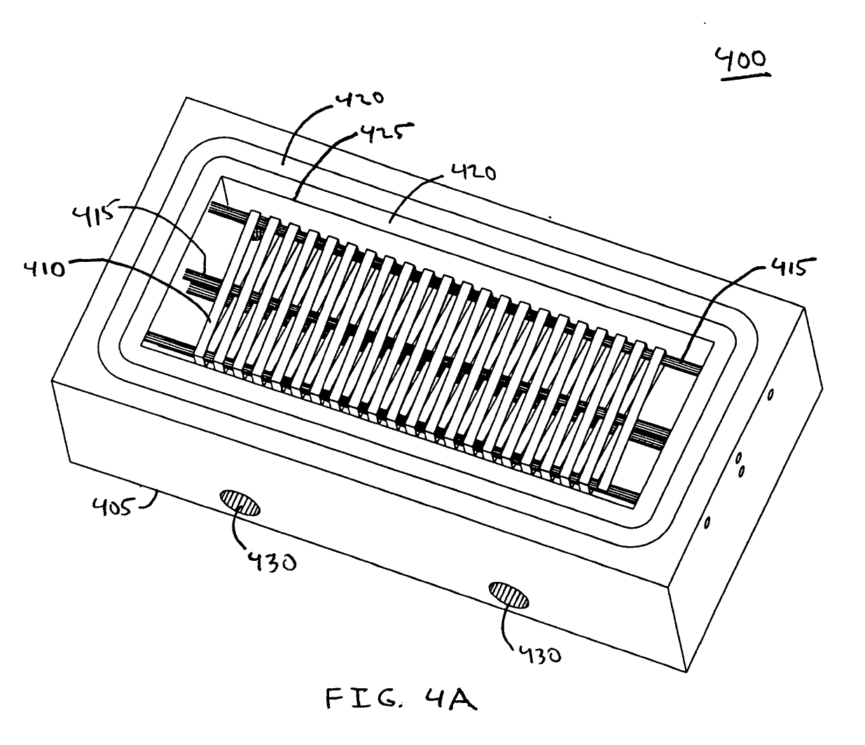

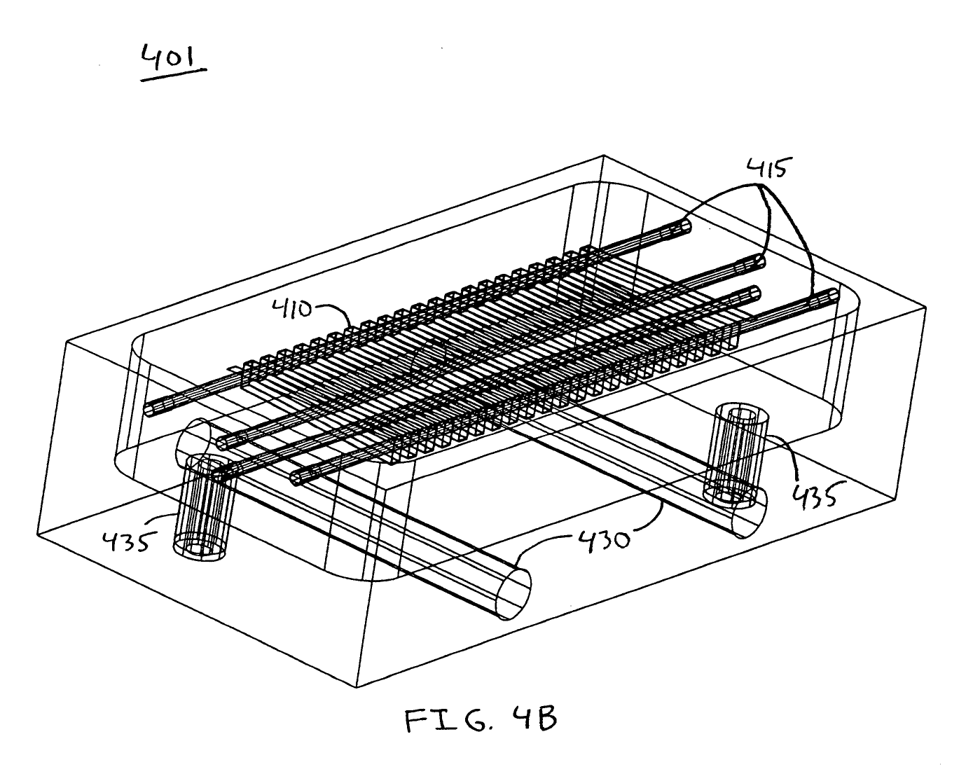

FIG. 4A shows a perspective view of a radiant heat source module 400 that may be used as heat source 225 in FIG. 2A and FIG. 2B. A housing 405 has a pair of cooling ports 430 for circulation of a coolant. Two layers of low density insulation 420 (e.g., alumina or zirconia fiber) and a hot face 425 (e.g., inconel sheet) serve to reduce heat loss and improve the uniformity of the radiant flux from the radiant heat source module 400. support rods 415 (e.g., alumina or mullite) support a heating element 410. Heating element 410 is preferably wound from a Ni—Cr alloy or Fe—Cr—Al alloy for use in air. A transparent quartz window may be used to enclose the radiant heat source module 400. If enclosed with the appropriate atmosphere (e.g., hydrogen/nitrogen), the radiant heat source module may have a heating element 410 wound from tungsten, molybdenum or other refractory metal.

FIG. 4B shows a perspective wireframe view 401 of a radiant heat source module 400. Feedthroughs 435 (e.g., alumina) provide access for connection to heating element 410

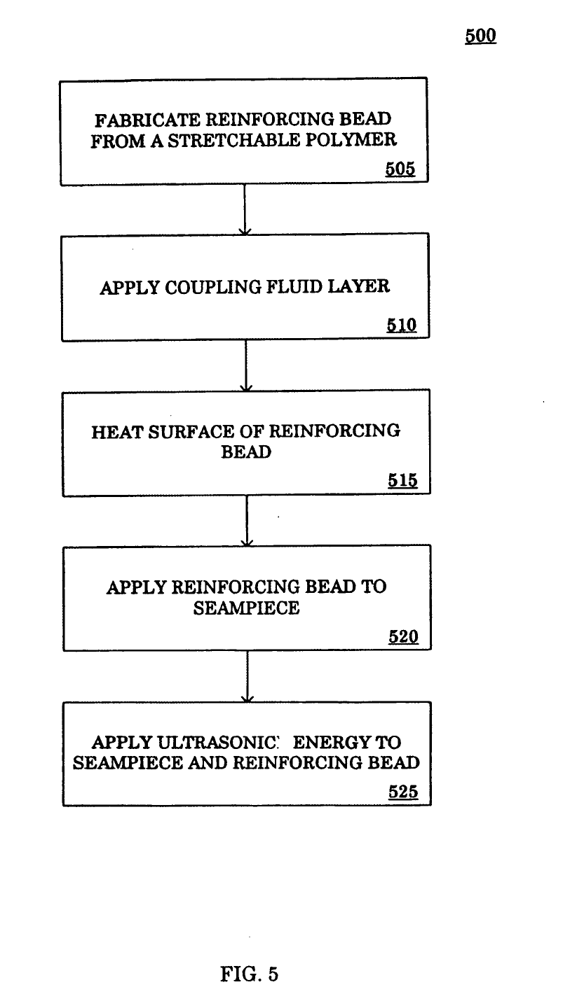

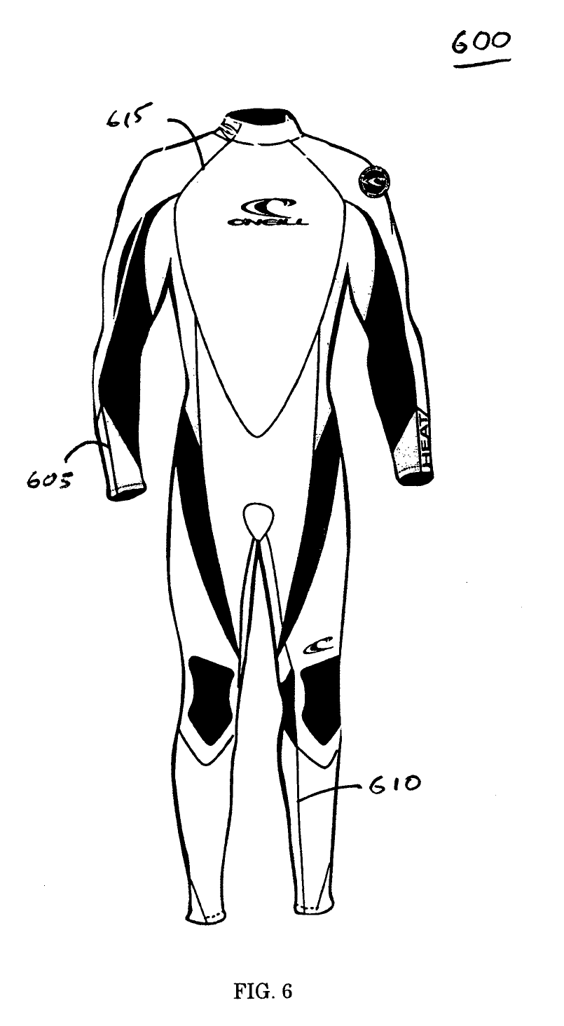

FIG. 5 shows a general flow chart 500 of a method for reinforcing a seam. At step 505 a reinforcing bead is fabricated from a stretchable polymer. The reinforcing bead may be fabricated by casting, extrusion, or by cutting from a flat or cylindrical sheet. The reinforcing bead may be fabricated with a higher than equilibrium concentration of solvent and/or plasticizer.

At step 510 a layer of coupling fluid may be applied to either reinforcing bead. A layer of coupling fluid may be applied to the seampiece to which the reinforcing bead is to be applied.

At step 515 the surface of the reinforcing bead may be heated. The heating may be done using a hot gas or by a radiant heat source.

At step 520 the reinforcing bead is applied to a seampiece such as a wetsuit part. The application may be performed by passing the reinforcing bead and seampiece between a pair of rollers. The surface hardness and shape of the rollers may be adapted to control the stress and strain states with the reinforcing bead as it passes between the pair of rollers. One of the rollers may serve as a rotating vacuum chuck to aid in positioning the reinforcing bead with respect to the seampiece.

At step 525 ultrasonic energy may be applied to the reinforcing bead and seampiece. The ultrasonic energy may be generated in the roller in contact with the seampiece.

FIG. 6 shows a front view of a wet suit 600 with seams reinforced in accordance with an embodiment of the present invention. Arm seam 605, leg seam 610 and torso seam 615 are examples of seam exteriors that may be reinforced. The seams may also be reinforced on the interior.

While the invention has been described in detail with reference to preferred embodiments thereof, it will be apparent to one skilled in the art that various changes can be made, and equivalents employed, without departing from the scope of the invention.

What is claimed:

1. A system for producing a wetsuit reinforcing bead, said system comprising:
a casting plate;
a plurality of grooves formed in an upper surface of said casting plate for receiving a liquid casting material; and
at least one coupling plug coupling two grooves of said plurality of grooves.

2. The system of claim 1 wherein at least one of said plurality of grooves has a maximum depth along its centerline.

3. A system for applying a reinforcing bead to a seampiece comprising a seam between two sheets of material, said system comprising:
a first pair of rollers for feeding said reinforcing bead to said seam;
a heat source for establishing a non-equilibrium temperature distribution within said reinforcing bead; and
a second pair of rollers for applying pressure to said reinforcing bead and said seam to bond said reinforcing bead to said seam.

4. The system of claim 3 further comprising a fluid applicator for applying a coupling fluid layer.

5. The system of claim 3 further comprising a fluid applicator for applying a coupling fluid layer.

6. The system of claim 3 further comprising a guide plate for guiding said reinforcing bead to said seam.

7. The system of claim 3 wherein one roller of said second pair of rollers is a rotating vacuum chuck.

8. The system of claim 3 wherein said heat source is a radiant heat source.

9. The system of claim 3 wherein said heat source is a hot gas jet.

10. The system of claim 3 wherein at least roller of said second pair of rollers has a contoured outer surface.

11. The system of claim 3 wherein at least roller of said first pair of rollers has a contoured outer surface.

12. A reinforcing bead for a wetsuit seam comprising:
a stretchable polymer;
a solvent/plasticizer for reducing the flow temperature of said stretchable polymer; and
wherein said reinforcing bead has a uniform cross-section along its length.

13. The reinforcing bead of claim 12 wherein said stretchable polymer comprises polyurethane.

14. The reinforcing bead of claim 13 wherein said solvent/plasticizer comprises toluene.

15. The reinforcing bead of claim 13 wherein said solvent plasticizer comprises dioctyl phthalate.

16. The reinforcing bead of claim 13 wherein said stretchable polymer comprises polychloroprene.

17. The reinforcing bead of claim 13 wherein said stretchable polymer comprises silicone.

18. The reinforcing bead of claim 13 wherein said stretchable polymer consists of an extrudable polymer.

19. The reinforcing bead of claim 13 wherein said reinforcing bead comprises at least one castable polymer.

20. The reinforcing bead of claim 19 wherein said reinforcing bead comprises at least two castable polymers.

21. A method for reinforcing a seam in a wetsuit, said method comprising heating a reinforcing bead to produce a non-equilibrium temperature distribution within said reinforcing bead and applying said reinforcing bead to said seam.

22. The method of claim 21 further comprising applying a coupling fluid layer to said reinforcing bead.

23. The method of claim 21 further comprising applying a coupling fluid layer to said seam.

24. The method of claim 21 wherein said heating is performed with a radiant heat source.

25. The method of claim 21 wherein said heating is performed with a hot gas jet.
